(19) United States
(12) Patent Application Publication
(10) Pub. No.: US 2019/0006960 A1
(43) Pub. Date: Jan. 3, 2019

(54) REVERSIBLE AC-DC AND DC-AC TRIAC CONVERTER

(71) Applicant: STMicroelectronics (Tours) SAS, Tours (FR)

(72) Inventors: Ghafour BENABDELAZIZ, Tours (FR); Cedric REYMOND, Tours (FR); David JOUVE, Saint-Antoine-du-Rocher (FR)

(73) Assignee: STMicroelectronics (Tours) SAS, Tours (FR)

(21) Appl. No.: 16/020,413

(22) Filed: Jun. 27, 2018

(30) Foreign Application Priority Data
Jun. 30, 2017 (FR) 1756179

(51) Int. Cl. H02M 7/797; H02M 1/08

(52) U.S. Cl. CPC H02M 7/797; H02M 2001/0048; H02M 1/08

(57) ABSTRACT

A reversible converter includes a first field effect transistor and a second field effect transistor that are coupled in series between a first terminal and a second terminal for a DC voltage. A first triac and a second triac are also coupled in series between the first and second terminals of the DC voltage. Midpoints of the series coupled devices are coupled, through an inductive element, to first and second terminals for an AC voltage. Actuation of the transistors and triacs is controlled in distinct manners to operate the converter in an AC-DC conversion mode and a DC-AC conversion mode.

### PRIORITY CLAIM

This application claims the priority benefit of French Application for Patent No. 1756179, filed on Jun. 30, 2017, the content of which is hereby incorporated by reference in its entirety to the maximum extent allowable by law.

### TECHNICAL FIELD

The present application generally relates to electronic circuits and, more particularly, to switching converters called totem pole output converters, or midpoint cascode converters.

### BACKGROUND

Switching converters are used in numerous applications and numerous types of converters are known.

Numerous rectifier bridge architectures and other bridgeless architectures are known among AC-DC converters, based on switching two transistors (generally MOS transistors) mounted in midpoint cascode (totem pole).

These converters are generally used for their efficiency in correcting the power factor (Power Factor Corrector—PFC).

There is a need to improve totem pole converters.

### SUMMARY

One embodiment provides a reversible totem pole converter architecture.

One embodiment provides a solution compatible with a limitation of the inrush current.

In an embodiment, a reversible AC-DC converter comprises: a first field effect transistor and a second field effect transistor in series between a first terminal and a second terminal intended for a DC voltage; an inductive element linking a first midpoint of the association in series of the two transistors to a first terminal intended for an AC voltage; and a first triac and a second triac in series between the DC voltage terminals, a second midpoint of the association in series of the two triacs being linked to a second terminal intended for the AC voltage.

According to one embodiment, a first diode is in parallel with the first transistor, on the first midpoint anode side, and a second diode is in parallel with the second transistor, on the first midpoint cathode side.

According to one embodiment, each diode is defined by the drain-source intrinsic diode of the transistor concerned.

According to one embodiment, a gate of each triac is second midpoint side.

According to one embodiment, a gate of each triac is on the side of the terminal of the DC voltage to which the triac concerned is connected.

According to one embodiment, a gate of the first triac is second midpoint side, and a gate of the second triac is second DC voltage terminal side.

In an embodiment, a method is presented for controlling such a converter. The method includes: switching the second triac on continuously during alternations of a first sign of the AC voltage; and switching the first triac on continuously during alternations of a second sign of the AC voltage.

According to one embodiment, in an AC-DC conversion mode, the second transistor is pulse controlled during the alternations of the first sign, and the first transistor is pulse controlled during the alternations of the second sign.

According to one embodiment, the first diode serves as a freewheeling diode.

According to one embodiment, in a DC-AC conversion mode, the first transistor is pulse controlled during the alternations of the first sign, and the second transistor is pulse controlled during the alternations of the second sign.

According to one embodiment, the second diode serves as a freewheeling diode.

### BRIEF DESCRIPTION OF THE DRAWINGS

These features and advantages, as well as others, will be disclosed in detail in the following non-restrictive description of particular embodiments in relation to the accompanying figures in which:

FIG. 1 is a wiring diagram of a common example of a totem pole AC-DC converter;

FIG. 2 schematically and partially represents, partly in the form of blocks, one embodiment of a reversible totem pole converter;

FIGS. 3A, 3B, 3C, 3D, 3E, 3F, 3G and 3H illustrate, in the form of timing diagrams, the operation of the converter in FIG. 2 in AC-DC conversion mode;

FIGS. 4A, 4B, 4C, 4D, 4E, 4F, 4G and 4H illustrate, in the form of timing diagrams, the operation of the converter in FIG. 2 in DC-AC conversion mode;

FIG. 5 represents in more details one embodiment of the reversible totem pole converter of FIG. 2;

FIG. 6 schematically and partially in the form of blocks, represents another embodiment of a reversible totem pole converter;

FIG. 7 schematically and partially in the form of blocks, represents another embodiment of a reversible totem pole converter; and

FIG. 8 schematically and partially in the form of blocks, represents an embodiment of a circuit for generating DC voltages for control circuits of a reversible totem pole converter.

### DETAILED DESCRIPTION

The same elements have been designated by the same references in the different figures. In particular, structural and/or functional elements common to the various embodiments may have the same references and may have identical structural, dimensional and material properties.

For the sake of clarity, only the steps and elements useful to the understanding of the embodiments that will be described have been represented and will be given in detail. In particular, the final application of the converter has not been detailed, the described embodiments being compatible with the common applications of AC-DC, DC-AC or reversible converters.

Unless specified otherwise, when reference is made to two interconnected elements, this means directly connected without any intermediate element other than conductors, and when reference is made to two interlinked elements, this means that these two elements may be directly linked (connected) or linked via one or more other elements.

In the description that follows, the expressions “approximately”, “substantially” and “of the order of” mean within 10%, preferably within 5%.

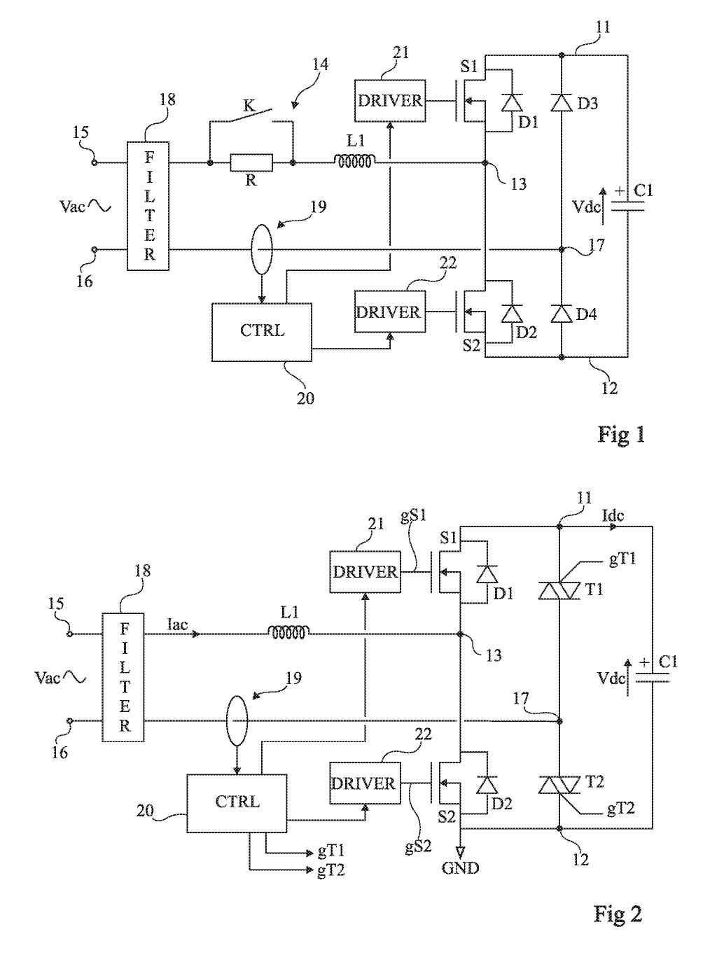

FIG. 1 is a wiring diagram of a common example of a totem pole AC-DC converter.

A totem pole converter is based on the use of two MOS transistors (here N-channel transistors) S1 and S2, connected in series between two terminals 11 and 12 for supplying a DC voltage Vdc. The drain of the transistor S1 is on the terminal 11 side and the source of the transistor S2 is on the terminal 12 side. A storage element C1 (capacitor or battery, for example) of the DC energy links the terminals 11 and 12, the terminal 11 being, arbitrarily, the positive terminal of the voltage Vdc. The midpoint 13 between the two transistors S1 and S2 is linked, via an inductive element L1 in series with a circuit 14 for limiting the inrush current and losses in steady state, to a first terminal 15 applying an AC voltage Vac. The circuit 14 is, for example, a resistor R (with a positive PTC or negative NTC temperature coefficient) in parallel with a switch K. The resistor R limits the inrush current at start-up and the switch K short circuits the resistor in steady state to limit the resistive losses once the voltage balance is reached. A second terminal 16 applying the AC voltage Vac is linked to the midpoint 17 of an association in series of two diodes D3 and D4 connected between the terminals 11 and 12. The anodes of the diodes D3 and D4 are, respectively, on the midpoint 17 side and terminal 12 side.

In practice, the terminals 15 and 16 correspond to the connection terminals connecting to the electrical distribution network and an input filter 18 (FILTER), or mains filter, is interposed between on the one hand the terminal 15 and the circuit 14 and, on the other hand, the terminal 16 and the midpoint 17. An element 19 for measuring the AC current is interposed between the filter 18 and the midpoint 17. The information representative of the current, measured by the element 19, is used by a control circuit 20 (CTRL) for controlling the conduction periods of the transistors S1 and S2. The circuit 20 receives other information such as, for example, information representative of the voltage Vdc, information representative of the energy requirements of the load connected to the terminals 11 and 12, etc. The circuit 20 supplies control signals to circuits (DRIVER) 21 and 22 for generating control signals for controlling the gates of the respective transistors S1 and S2. The intrinsic source-drain diodes D1 and D2 of the transistors S1 and S2 are also represented in FIG. 1. The transistors S1 and S2 are controlled in pulse width modulation according to the requirements of the load connected to the terminals 11 and 12. The pulse frequency is generally fixed and is markedly higher (ratio of at least 100, e.g. from a few kHz to a few hundreds of kHz) than the frequency of the voltage Vac (generally less than 100 Hz, typically 50 Hz or 60 Hz for the electrical distribution network).

The operation of the totem pole converter in FIG. 1 is as follows. For simplicity, the presence of the filter 18 is not taken into account, but it is of course passed through by the current from the terminals 15 and 16 and towards these terminals.

During the positive alternations of the voltage Vac, the transistor S2 is controlled in pulse width modulation to be periodically closed (on) and the transistor S1 remains permanently open (off). Furthermore, the source-drain diode D2 of the transistor S2 is reverse biased while the source-drain diode D1 of the transistor S1 is forward biased and serves as a freewheeling diode. During the closure pulses of the transistor S2, the inductor L1 stores energy. The current flows from the terminal 15, via the inductor L1, the transistor S2 and the diode D4 to the terminal 16. The DC load connected to the terminals 11 and 12 is powered by the energy stored in the energy storage element C1 (capacitor or battery). At each opening of the transistor S2, the energy stored in the inductor L1 is transferred to the DC load. The current then flows from the inductor L1, via the diode D1 of the transistor S1 to the positive terminal 11, then from the negative terminal 12, via the diode D4 to the terminal 16 to loop back onto the inductor L1. In some cases, the diode D1 is a diode in parallel with the transistor S1.

During the negative alternations of the voltage Vac, the transistor S1 is controlled in pulse width modulation to be periodically closed (on) and the transistor S2 remains permanently open (off). Furthermore, the source-drain diode D1 of the transistor S1 is reverse biased while the source-drain diode D2 of the transistor S2 is forward biased and serves as a freewheeling diode. During the closure pulses of the transistor S1, the inductor L1 stores energy. The current flows from the terminal 16, via the diode D3, the transistor S1 and the inductor L1 to the terminal 15. The DC load connected to the terminals 11 and 12 is powered by the energy stored in the energy storage element C1. At each opening of the transistor S2, the energy stored in the inductor L1 is transferred to the DC load. The current then flows from the inductor L1, via the terminals 15 then 16, the diode D3, to the positive terminal 11, then from the negative terminal 12, via the diode D2 to the inductor L1.

The inrush current limiting circuit 14 is used before each closure pulse of one of the transistors S1 and S2, in particular when farther away from the zero cross of the voltage Vac. Indeed, the voltage at the terminals of the transistor S1 or S2 when it is closed increases when approaching the middle of the corresponding alternation, which, without a limiting circuit would cause a current peak. The opening of the switch K, in a pulsewise manner, before each start of closure pulse of the transistors S1 and S2 so that the resistor R limits the charging current of capacitor C1, avoids these current peaks, in particular towards the middle of each alternation.

The converter in FIG. 1 is unidirectional, i.e. it can only operate as an AC-DC converter (rectifier mode). In some applications it is desirable to have a reversible converter, i.e. also capable of operating as a DC-AC converter. This is used, for example, to reinject energy into the electrical distribution network or to power a motor from a battery. The converter must then be capable of operating as an inverter.

The described embodiments provide for benefiting from the advantages of a totem pole architecture and the performance thereof to produce a reversible converter.

One example of an application of a reversible converter is to make it possible, with the same converter, both to supply a load from the electrical distribution network and to inject energy into the network when the load is not consuming.

Another example of an application of a reversible converter is to make it possible, with the same converter, both to power a motor (transfer of electrical-mechanical energy) from a battery and to recharge the battery (transfer of mechanical-electrical energy) from the rotation of the motor.

It is also conceivable to use MOS transistors instead of the diodes D3 and D4 in order to make the structure bidirectional. However, the need to limit the inrush current makes this a very restrictive solution in terms of control of the MOS transistors and space requirement and reliability of the circuit for limiting losses in steady state. The inrush current limiting circuit 14 is also essential.

It would also be possible to think of using thyristors in place of the diodes D3 and D4. However, this would not suffice to render the converter bidirectional.

FIG. 2 schematically and partially represents, partly in the form of blocks, one embodiment of a reversible totem pole converter.

A totem pole structure is found with two field effect transistors S1 and S2, e.g. MOS transistors (here N-channel transistors), connected in series between two terminals 11 and 12 with a DC voltage Vdc. The drain of the transistor S1 is on the terminal 11 side and the source of the transistor S2 is on the terminal 12 side. A storage element C1 (capacitor or battery, for example) of the DC energy links the terminals 11 and 12, the terminal 11 being, arbitrarily, the positive terminal of the voltage Vdc.

The midpoint 13 between the two transistors S1 and S2 is linked, via an inductive element L1, to the first terminal 15 of an AC voltage Vac. According to the described embodiments, provision is made to replace the diodes D3 and D4 in FIG. 1 with triacs. Thus, a second terminal 16 of the AC voltage Vac is linked to the midpoint 17 of a series association of two triacs T1 and T2 connected between the terminals 11 and 12. In the example of FIG. 2, the gates gT1 and GT2 of the triacs T1 and T2 are respectively terminal 11 side and terminal 12 side.

As will be seen later, thanks to the solution provided, an inrush current limiting circuit (14, FIG. 1) is not necessary.

The terminals 15 and 16 correspond, for example, to the connection terminals connecting to the electrical distribution network or to the terminals of a motor, etc., and an input filter 18 (FILTER), or mains filter, is preferably interposed between on the one hand the terminal 15 and the node 13 and, on the other hand, the terminal 16 and the midpoint 17. An element 19 for measuring the AC current is interposed between the filter 18 and the midpoint 17. The information representative of the current measured by the element 19, is used by a control circuit 20 (CTRL) for controlling the conduction periods of the transistors S1 and S2 and the triacs T1 and T2. The circuit 20 receives other information such as, for example, information representative of the voltage Vdc, information representative, in rectifier mode, of the requirements of the DC load connected to the terminals 11 and 12, etc. The circuit 20 supplies control signals to circuits (DRIVER) 21 and 22 for generating control signals for controlling the gates gS1 and gS2 of the respective transistors S1 and S2 and also, directly or indirectly, control signals to the triggers gT1 and gT2 of the triacs T1 and T2. The intrinsic source-drain diodes D1 and D2 of the transistors S1 and S2 are also represented in FIG. 2. As a variant, the diodes D1 and D2 may be additional components. According to another variant, the transistor S1 or S2 is switched on during the periods when the current has to flow in the diode D1, respectively D2. This makes it possible to reduce the losses by conduction in relation to a flow of current in the intrinsic diode D1 or D2. The transistors S1 and S2 are controlled in pulse width modulation. The pulse frequency is generally fixed and is markedly higher (ratio of at least 100, e.g. from a few kHz to a few hundreds of kHz) than the frequency of the voltage Vac (generally less than 100 Hz, typically 50 Hz or 60 Hz for the electrical distribution network). The converter neither raises nor reduces the voltage either in one direction or another. Only the AC-DC conversion and vice versa is concerned here. Where appropriate, other systems of conversion and regulation are present upstream or downstream for reducing or increasing the values of the voltages Vac and Vdc.

The use of triacs in a totem pole architecture seems at first sight useless because of the presence of the transistors S1 and S2. However, as is apparent from the embodiments below, the use of two triacs instead of two diodes makes it possible not only to avoid the inrush current limiting circuit, but also to make the converter reversible with a particularly simple control.

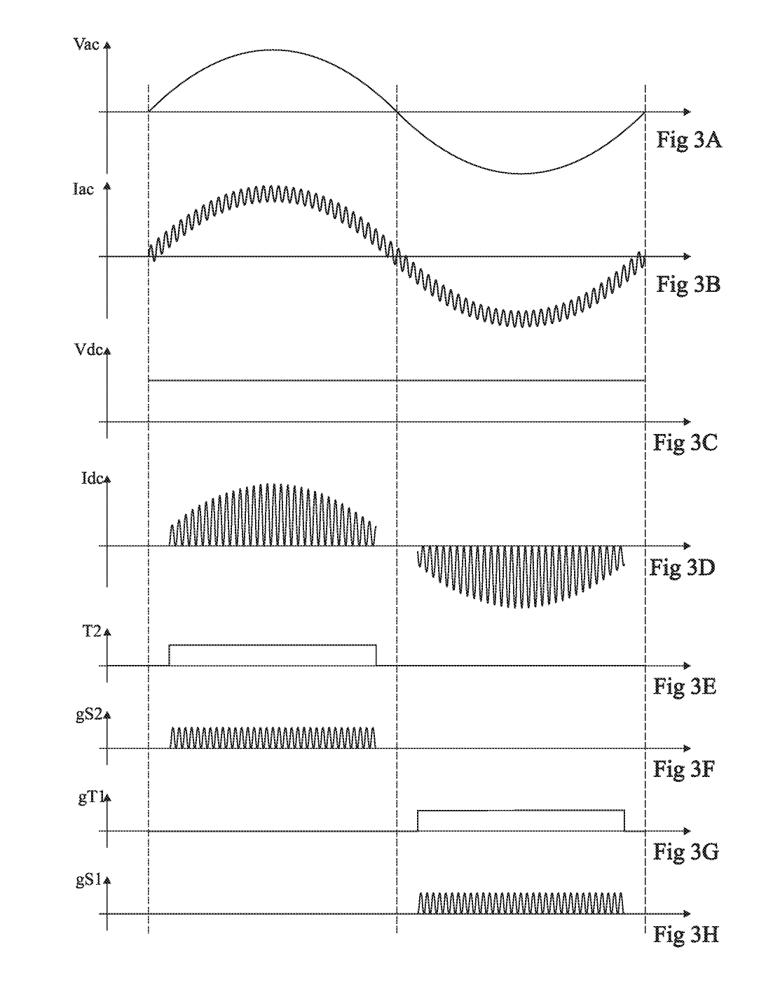

FIGS. 3A, 3B, 3C, 3D, 3E, 3F, 3G and 3H illustrate, in the form of timing diagrams, the operation of the converter in FIG. 2 in AC-DC conversion mode in the course of a period of the AC voltage Vac.

FIG. 3A represents an example of behavior of the voltage Vac between the terminals 15 and 16 (line or motor voltage). FIG. 3B represents a corresponding example of behavior of the current Iac (line or motor current). FIG. 3C represents an example of corresponding behavior of the voltage Vdc between the terminals 11 and 12 (battery voltage or of the capacitor C1). FIG. 3D represents a corresponding example of behavior of the current Idc on the DC voltage side. FIG. 3E represents an example of closure periods of the triac T2. FIG. 3F represents an example of corresponding behavior of the gate gS2 voltage of the transistor S2. FIG. 3G represents an example of closure periods of the triac T1. FIG. 3H represents an example of corresponding behavior of the gate gS1 voltage of the transistor S1.

Steady state is now considered, i.e. it is assumed that the capacitor C1 is at the charge level required by the application. The operation at start-up is similar but the voltage Vdc increases gradually over multiple alternations until reaching its nominal level set by the application. For simplifying the explanations, the presence of the filter 18 is ignored in what follows.

In AC-DC conversion mode, the triac T2 is switched on during the positive alternations of the voltage Vac while the triac T1 is switched on during the negative alternations of the AC voltage. However, unlike the diodes D3 and D4 of the conventional case in FIG. 1, placing the triacs T1 and T2 in conduction does not depend on the periods of conduction of the transistors S1 and S2, but is forced during the maximum possible duration of the positive and negative alternations. This duration covers at least the whole duration of the control pulse train of the transistors S1 and S2, and is set by the half-period of the AC voltage. Thus, the closure of the transistor S1 or S2 (according to the alternation of the voltage Vac) takes place while the voltage at the terminals of same is approximately zero. The control of the transistors S1 and S2 is not modified by the described embodiments. It will be noted that a triac turns off, in the absence of control, when the current which passes through it vanishes (becomes less than its sustaining current). Thus, because of the discontinuity of the current during each alternation, in order to avoid an untimely turning off of the triac T1 or T2, the control is sustained for approximately the whole duration of an alternation (negative for the triac T1 and positive for the triac T2). The control of the triac concerned is interrupted at the end of the alternation.

During the positive alternations of the voltage Vac, the transistor S2 is controlled in pulse width modulation to be periodically closed (on) and the transistor S1 remains permanently open (off). Furthermore, the source-drain diode D2 of the transistor S2 is reverse biased while the source-drain diode D1 of the transistor S1 is forward biased and serves as a freewheeling diode. During the closure pulses of the transistor S2, the inductor L1 stores energy. The current flows from the terminal 15, via the inductor L1, the transistor S2 and the triac T2 to the terminal 16. The DC load connected to the terminals 11 and 12 is powered by the energy stored in the energy storage element C1 (capacitor or battery). At each opening of the transistor S2, the energy stored in the inductor L1 is transferred to the DC load. The current then flows from the inductor L1, via the diode D1 of the transistor S1 to the positive terminal 11, then from the negative terminal 12, via the triac T2 to the terminal 16 to loop back onto the inductor L1.

During the negative alternations of the voltage Vac, the transistor S1 is controlled in pulse width modulation to be periodically closed (on) and the transistor S2 remains permanently open (off). Furthermore, the source-drain diode D1 of the transistor S1 is reverse biased while the source-drain diode D2 of the transistor S2 is forward biased and serves as a freewheeling diode. During the closure pulses of the transistor S1, the inductor L1 stores energy. The current flows from the terminal 16, via the triac T1, the transistor S1 and the inductor L1 to the terminal 15. The DC load connected to the terminals 11 and 12 is powered by the energy stored in the energy storage element C1. At each opening of the transistor S2, the energy stored in the inductor L1 is transferred to the DC load. The current then flows from the inductor L1, via the terminals 15 then 16, the triac T1, to the positive terminal 11, then from the negative terminal 12, via the diode D2 to the inductor L1.

The use of triacs T1 and T2 has another advantage which is to allow operation as an inverter, i.e. in DC-AC conversion. The fact that the triacs are bidirectional is exploited here.

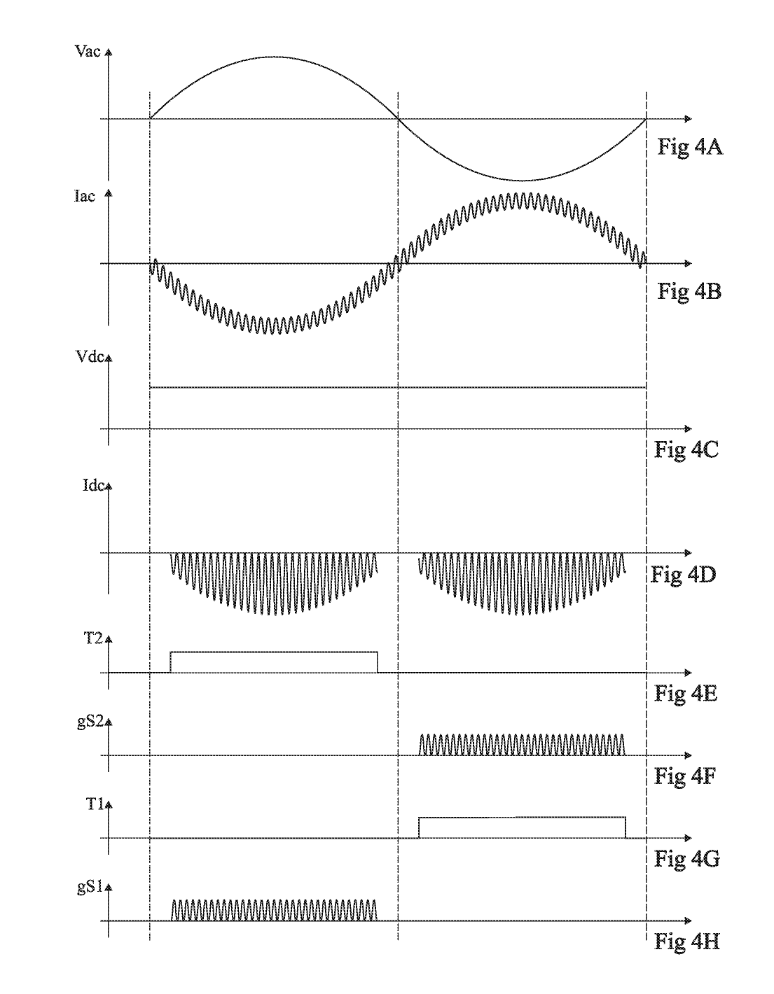

FIGS. 4A, 4B, 4C, 4D, 4E, 4F, 4G and 4H illustrate, in the form of timing diagrams, the operation of the converter in FIG. 2 in DC-AC conversion mode in the course of a period of the AC voltage Vac.

FIG. 4A represents an example of behavior of the voltage Vac between the terminals 15 and 16 (line or motor voltage). FIG. 4B represents a corresponding example of behavior of the current Iac (line or motor current). FIG. 4C represents an example of corresponding behavior of the voltage Vdc between the terminals 11 and 12 (battery voltage or of the capacitor C1). FIG. 4D represents a corresponding example of behavior of the current Idc on the DC voltage side. FIG. 4E represents an example of closure periods of the triac T2. FIG. 4F represents an example of corresponding behavior of the gate gS2 voltage of the transistor S2. FIG. 4G represents an example of closure periods of the triac T1. FIG. 4H represents an example of corresponding behavior of the gate gS1 voltage of the transistor S1.

In inverter mode, the question of the steady state of the voltage Vdc does not arise. Indeed, here it is a matter of transferring energy from the DC source (charged battery, for example) to the AC load.

For operating as an inverter, i.e., for example, reinjecting energy into the electrical distribution network or powering a motor, the direction of flow of the current in the converter must be reversed with respect to the case of the AC-DC converter. Thus, with the same sign conventions, the current Idc is always negative. Furthermore, the sign of the current Iac is reversed with respect to the sign of the voltage Vac, i.e. it is negative during the positive alternations and positive during the negative alternations.

As for the rectifier mode, the triac T2 is switched on continuously during the positive alternations of the AC voltage Vac while the triac T1 is switched on continuously during the negative alternations of the AC voltage Vac. However, on the transistors S1 and S2 side, unlike the rectifier mode, the transistor S1 is controlled during the positive alternations and the transistor S2 is controlled during the negative alternations of the voltage Vac. The transistors S1 and S2 are always pulse controlled, preferably in pulse width modulation if the AC load is likely to vary (e.g. in the case of a motor).

During the positive alternations of the voltage Vac, the transistor S1 is controlled in pulse width modulation to be periodically closed (on) and the transistor S2 remains permanently open (off). Furthermore, the source-drain diode D1 of the transistor S1 is reverse biased while the source-drain diode D2 of the transistor S2 is forward biased and serves as a freewheeling diode. During the closure pulses of the transistor S1, the inductor L1 stores energy. The current flows from the terminal 11, via the transistor S1 and the inductor L1 to the terminal 15, then from the terminal 16, via the triac T2 to the terminal 12. At each opening of the transistor S1, the energy stored in the inductor L1 is transferred to the AC network (or to the motor). The current then flows from the inductor L1 to the terminal 15, then from the terminal 16, via the triac T2 and the diode D2 to the inductor L1.

During the negative alternations of the voltage Vac, the transistor S2 is controlled in pulse width modulation to be periodically closed (on) and the transistor S1 remains permanently open (off). Furthermore, the source-drain diode D2 of the transistor S2 is reverse biased while the source-drain diode D1 of the transistor S1 is forward biased and serves as a freewheeling diode. During the closure pulses of the transistor S2, the inductor L1 stores energy. The current flows from the terminal 11, via the triac T1 to the terminal 16, then from the terminal 15, via the inductor L1 and the transistor S2 to the terminal 12. At each opening of the transistor S2, the energy stored in the inductor L1 is transferred to the AC network. The current then flows from the inductor L1, via the diode D1, the triac T1 to the terminal 16, and loops back via the terminal 15 into the inductor L1.

In relation to the rectifier mode, it is made sure that at each end of alternation, the control pulses of the transistors S1 and S2 are halted sufficiently early to ensure that the current Iac is zero at the end of the alternation.

The applications more particularly targeted are applications in which the voltages Vac and Vdc have amplitudes greater than 100 volts. However, the control signals of the transistors S1 and S2 and the triacs T1 and T2 have amplitudes ranging from a few volts to 10-20 volts. Consequently, circuits must be provided for generating these control signals having appropriate voltage references.

The following figures highlight the power supply connections and potentials required for the control signals of the transistors and triacs in various embodiments.

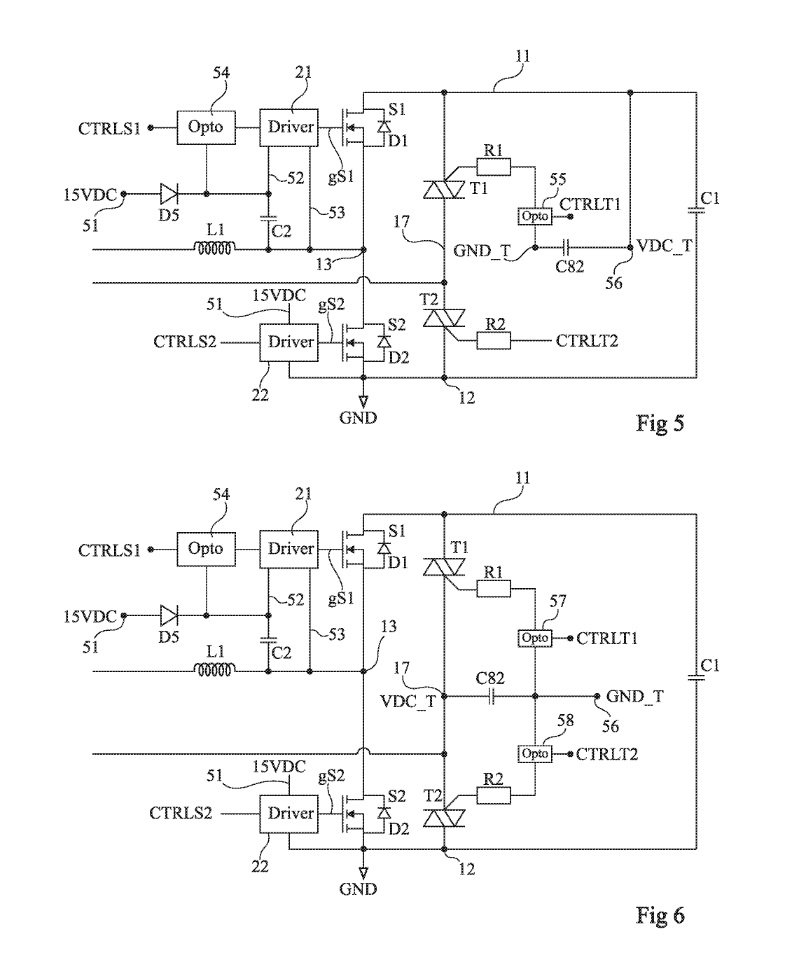

FIG. 5 represents in more details one embodiment of the reversible totem pole converter of FIG. 2.

On the transistor S2 side, its source being the ground GND (potential of the terminal 12), the reference potential of its gate gS2 control signal may also be the ground GND. The circuit 22 is, for example, powered by a positive voltage 15 VDC (terminal 51), of 15 volts, referenced to the ground GND and receives a low voltage digital signal CTRLS2 (of a few volts, e.g. 3-5 volts) from the circuit 20 (e.g. a microcontroller).

On the transistor S1 side, the voltage of the terminal 11 is too high to allow a control gS1 referenced to the ground GND. In the example of FIG. 5, provision is made to reference the power supply voltage, e.g. 15 volts, of the circuit 21 to the node 13. As the node 13 corresponds to the source of the transistor S1, a positive gate-to-source voltage is ensured regardless of the potential of the node 13 (which evolves with the voltage Vac). A potential 15 VDC of 15 volts (referenced to the ground GND) is applied to the anode of a diode D5 the cathode of which is linked to a terminal 52 for applying the positive power supply potential of the circuit 21. A terminal 53 for applying the reference potential of the circuit 21 is connected to the node 13. A capacitor C2 links the cathode of the diode D5 to the node 13 for adapting the voltage reference of 15 volts powering the circuit 21. Because of the voltage reference change, a low voltage control signal CTRLS1, supplied by the circuit 20, is applied via an optocoupler 54 (Opto) the conduction terminals of which (the emitter and the collector of the bipolar output phototransistor) are respectively linked to the terminal 52 and to a control input terminal of the circuit 21. The signal CTRLS1 is applied to the control terminal of the optocoupler (the anode of its photodiode) by being referenced to the ground GND.

Triac T1 side, a gate current of the triac T1 is injected by the transistor of an optocoupler 55 (Opto) whose conduction terminals (emitter and collector of the phototransistor) are connected to an electrode of a capacitor C82 defining a floating ground GNT_T of a DC power supply (for example, of the order of 15 volts) isolated (floating) and, by a resistor R1, to the gate of the triac T1. Another electrode of the capacitor C82 is connected to a terminal 56 for application of the floating positive potential VDC_T of the isolated DC power supply referenced to the potential GND_T. In the example of FIG. 5, the terminals 11 and 56 are merged. The gate current is therefore extracted from the triac T1. As a variant, the terminals VDC_T and GND_T are inverted and the gate current is injected into the triac T1. A low voltage control signal CTRLT1, supplied by the circuit 20, is applied to the control terminal of the optocoupler 55 (the anode of its photodiode) by being referenced to the ground GND.

Triac T2 side, one of the electrodes of which is connected to the ground GND, a gate current can be injected directly originating from the circuit 20 by application of a low-voltage control signal CTRLT2, by way of a resistor R2.

FIG. 6 represents, in a schematic manner and partially in the form of blocks, another embodiment of a reversible totem pole converter.

With respect to the diagram of FIG. 5, the gates of the triacs T1 and T2 are midpoint 17 side.

Two optocouplers 57 and 58 (Opto) are then used, whose respective control terminals (photodiodes) receive the low-voltage signals CTRLT1 and CTRLT2 provided by the circuit 20 (not represented in FIG. 6) and referenced to the ground GND.

In the example of FIG. 6, it is assumed that it is desired to extract the gate currents of the triacs T1 and T2. The conduction terminals (the emitter and the collector of the phototransistor) of the optocouplers 57 and 58 are respectively linked, by way of the resistors R1 and R2, to the gates of the triacs T1 and T2 and to a terminal 56 for application of the floating ground GND_T of the isolated DC power supply. In this embodiment, the floating positive potential VDC_T (for example, of the order of 15 volts) corresponds to the potential of the midpoint 17, the capacitor C82 linking the midpoint 17 and the terminal 56. The remainder of the setup is identical to that of FIG. 5.

As a variant, the relation between the potentials of the terminals 56 (VDC_T) and 17 (GND_T) is inverted and the gate currents of the triacs T1 and T2 are injected into the gates instead of being extracted from the gates.

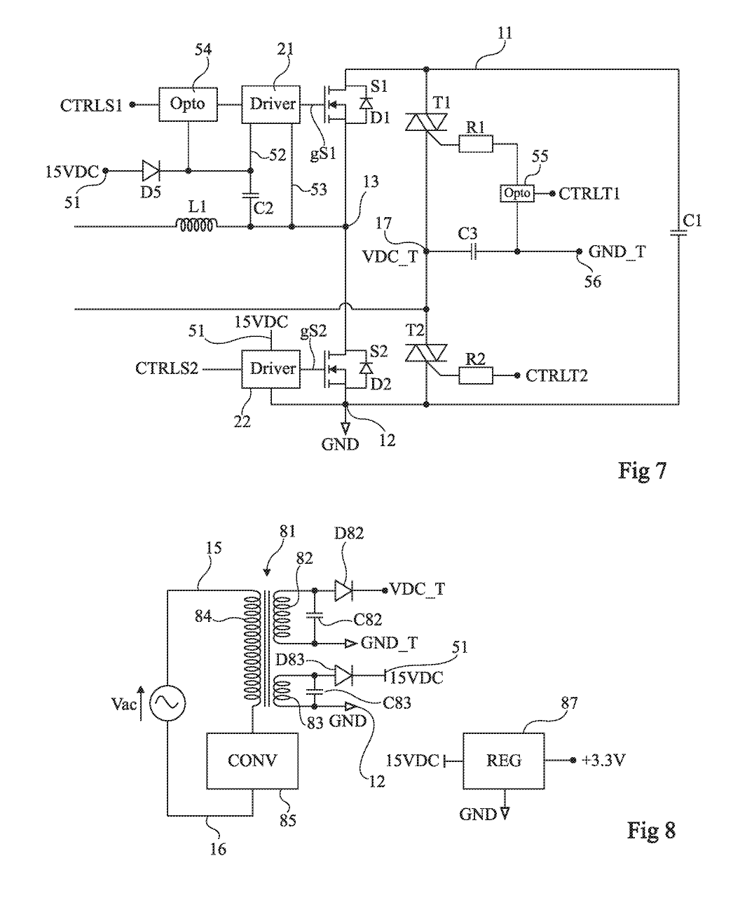

FIG. 7 schematically and partially in the form of blocks, represents another embodiment of a reversible totem pole converter.

With respect to the embodiment of FIG. 6, the gate of the triac T2 is terminal 12 side (as in FIG. 5). The signal CTRLT2 can therefore be applied directly thereto.

FIG. 8 schematically and partially in the form of blocks, represents an embodiment of a circuit for generating DC voltages for control circuits of a reversible totem pole converter.

This figure illustrates an example of circuit set-up for generating the potentials VDC_T, GND_T and 15 VDC from the AC voltage Vac.

A transformer 81 with two secondary windings 82 and 83 is used. A primary winding 84 of the transformer is linked, where appropriate via the filter 18 (FIG. 2), between the terminal 15 (FIG. 2) and a terminal of a switching converter 85 (CONV), e.g. an integrated circuit known under the trade name of VIPER, the other terminal of which is linked, where appropriate via the filter 18 (FIG. 2), to the terminal 16 (FIG. 2).

The first secondary winding 82 of the transformer 81 supplies the floating voltage (for example, of the order of 15 volts) VDC_T-GND_T. For this, a first terminal of the winding 82 defines the potential GND_T and is linked to the optocoupler 55 in the embodiment in FIG. 5 or to the terminal 56 in the embodiments in FIGS. 6 and 7. A second terminal of the winding 82 is linked at the input (anode) of a rectifying element D82 (e.g. a diode) and a capacitor C82 links the two terminals of the winding 82. The output (cathode) of the rectifying element D82 defines the potential VDC_T and is linked to the terminal 56 in the embodiment in FIG. 5 or to the midpoint 17 in the embodiments in FIGS. 6 and 7.

The second secondary winding 83 of the transformer 81 supplies the voltage 15 VDC-GND. For this, a first terminal of the winding 83 defines the potential GND and is linked to the terminal 12 (FIGS. 5 to 7). A second terminal of the winding 83 is linked at the input (anode) of a rectifying element D83 (e.g. a diode) and a capacitor C83 links the two terminals of the winding 83. The output (cathode) of the rectifying element D83 defines the potential 15 VDC and is linked to the terminal 51 (FIGS. 5 to 7).

The amplitudes of the voltages VDC_T-GND_T and 15 VDC-GND depend on the transformation ratios of the windings 82 and 83 in relation to the winding 84.

The voltage 15 VDC-GND may be used to generate the low voltage (e.g. 3.3 volts) referenced to the ground GND for the circuit or microcontroller 20. For this, a linear regulator 87 (REG) is used, for example.

One advantage of the described embodiments is that the totem pole converter thus produced is particularly efficient. In particular, it overcomes the need for an inrush current limiting circuit, while obtaining a reversible converter.

Particular embodiments have been described. Various variants and modifications will be apparent to the person skilled in the art. In particular, the choice of circuit set-up from among those of FIGS. 5 to 7 depends on the application and the circuit used to generate the control voltages. Indeed, the circuit in FIG. 8 is only one example and the voltages present in the rest of the application may be used as a variant. Moreover, the practical implementation of the embodiments and the dimensioning of the components is within the grasp of the person skilled in the art from the functional description given above.

1. A reversible converter, comprising:
a first field effect transistor and a second field effect transistor coupled in series between a first terminal and a second terminal associated with a DC voltage;
an inductive element linking a first midpoint of the series coupling of the first and second field effect transistors to a first terminal associated with an AC voltage; and
a first triac and a second triac coupled in series between the first and second terminals associated with the DC voltage, wherein a second midpoint of the series coupling of the first and second triacs being linked to a second terminal associated with said AC voltage.

2. The converter according to claim 1, further comprising:
a first diode connected in parallel with the first field effect transistor with a anode terminal of the first diode coupled to the first midpoint; and
a second diode connected in parallel with the second field effect transistor with a cathode terminal coupled to the first midpoint.

3. The converter according to claim 2, wherein each diode of the first and second diodes is an intrinsic drain-source diode of a field effect transistor.

4. The converter according to claim 1, wherein a gate of each triac of the first and second triacs is on a side associated with the second midpoint.

5. The converter according to claim 1, wherein a gate of each triac of the first and second triacs is on a side associated with a corresponding one of the first and second terminals associated with the DC voltage.

6. The converter according claim 1, wherein:
a gate of the first triac is on a side associated with the second midpoint; and
a gate of the second triac is on a side associated with the second terminal associate with the DC voltage.

7. The converter according to claim 1, further comprising a control circuit configured to control converter operation by:
switching the second triac on continuously during alternations of a first sign of the AC voltage; and
switching the first triac on continuously during alternations of a second sign of the AC voltage.

8. The converter according to claim 7, wherein the control circuit further, in an AC-DC conversion mode:
pulse controls the second field effect transistor during the alternations of the first sign; and
pulse controls the first field effect transistor during the alternations of the second sign.

9. The converter according to claim 7, wherein the control circuit further, in a DC-AC conversion mode:
pulse controls the first field effect transistor during the alternations of the first sign; and
pulse controls the second field effect transistor during the alternations of the second sign.

10. A method of controlling a converter operable in both an AC-DC conversion mode and a DC-AC conversion mode, wherein the converter includes a first field effect transistor and a second field effect transistor coupled in a first series between terminals associated with a DC voltage, a first triac and a second triac coupled in a second series between the first and second terminals associated with the DC voltage, and wherein midpoints of the first and second series are coupled to terminals associated with an AC voltage, the method comprising:
switching the second triac on continuously during alternations of a first sign of the AC voltage during both the AC-DC conversion mode and the DC-AC conversion mode; and
switching the first triac continuously during alternations of a second sign of the AC voltage during both the AC-DC conversion mode and the DC-AC conversion mode.

11. The method according to claim 10, further comprising, in the AC-DC conversion mode:
pulse controlling the second field effect transistor during the alternations of the first sign; and
pulse controlling the first field effect transistor during the alternations of the second sign.

12. The method according to claim 11, wherein the converter further includes a diode coupled in parallel with each of the first field effect transistor and second field effect transistor, said diodes operating as freewheeling diodes.

13. The method according to claim 10, further comprising, in the DC-AC conversion mode:
pulse controlling the first transistor during the alternations of the first sign; and
pulse controlling the second transistor during the alternations of the second sign.

14. The method according to claim 13, wherein the converter further includes a diode coupled in parallel with each of the first field effect transistor and second field effect transistor, said diodes operating as freewheeling diodes.

15. A reversible converter, comprising:
a first field effect transistor and a second field effect transistor coupled in series between DC voltage terminals;
a first triac and a second triac coupled in series between said DC voltage terminals;
wherein midpoints of connection between the first and second field effect transistors and the first and second triacs are coupled to AC voltage terminals; and
a control circuit configured to control actuation of the first and second field effect transistors and the first and second triacs to selectively operate the converter in a DC-AC conversion mode and an AC-DC conversion mode.

16. The converter according to claim 15, wherein the control circuit, when operating in the AC-DC conversion mode:
switches the second triac on continuously during alternations of a first sign of the AC voltage;
switches the first triac on continuously during alternations of a second sign of the AC voltage;
pulse controls the second field effect transistor during the alternations of the first sign; and
pulse controls the first field effect transistor during the alternations of the second sign.

17. The converter according to claim 15, wherein the control circuit, when operating in the DC-AC conversion mode:
switches the second triac on continuously during alternations of a first sign of the AC voltage;
switches the first triac on continuously during alternations of a second sign of the AC voltage; pulse controls the first field effect transistor during the alternations of the first sign; and
pulse controls the first field effect transistor during the alternations of the first sign; and
pulse controlling the second field effect transistor during the alternations of the second sign.

18. The converter according to claim 15, further comprising an inductor coupled between one of the midpoints and one terminal of the AC voltage.
